(19) United States
(12) Patent Application Publication
(10) Pub. No.: US 2011/0036276 A1
(43) Pub. Date: Feb. 17, 2011

(54) Wire Management Vanity Panel for Folding Table

(76) Inventors: Tad Petrick, Evanston, IL (US); Philip Sopicki, Glenview, IN (US); Chris Brandel, Chicago, IL (US); Cary Brown, Round Lake, IL (US); Morad Ghassemian, Oak Park, IL (US); Chris Kulujian, Chicago, IL (US)

Correspondence Address: Anderson Gorecki & Manaras, LLP;Attn: John C. Gorecki, P.O BOX 553, CARLISLE, MA, 01741, US

(21) Appl. No.: 12/913,895

(22) Filed: Oct. 28, 2010

Related U.S. Application Data
(63) Continuation of application No. PCT/US2010/021214, filed on Jan. 15, 2010.
(60) Provisional application No. 61/145,565, filed on Jan. 18, 2009.

(51) Int. Cl. A47B 37/00; F16L 3/22; A47B 3/00

(52) U.S. Cl. 108/42; 248/68.1

(57) ABSTRACT

A table includes a folding modesty panel and integrated wire management system. A folding portion of the modesty panel is shaped to retain wires within a channel in both a folded position and a deployed position. When the table is to be folded for storage, the modesty panel is folded up against the underside of the work surface and the work surface is then pivoted to a vertical orientation. The channel wires are retained within the channel between the movable portion of the modesty panel and the underside of the work surface to secure the wires while the table is in the storage position. When the table is deployed, the modesty panel may be unfolded to extend below the underside of the work surface. The modesty panel defines a channel in this position as well to also retain the wires while the modesty panel is in the unfolded deployed position.

### CROSS-REFERENCE TO RELATED APPLICATIONS

This application is a continuation of international application PCT/US2010/021214, filed Jan. 15, 2010, which claims priority to U.S. Provisional Patent Application No. 61/145,565, filed Jan. 18, 2009, entitled TABLE, the content of each of which is hereby incorporated herein by reference.

### BACKGROUND OF THE INVENTION

1. Field of the Invention

The present invention relates to folding tables and, more particularly, to a wire management vanity panel for a folding table.

2. Description of the Related Art

Multi-use facilities such as conference centers, training centers, educational facilities, and other types of physical spaces may be used for many different purposes. Frequently, the different purposes may require furniture within the facility to be rearranged. For example, if a facility is to be used for a conference, the same physical space may be used for lectures/presentations during the day, as a dining area in the evening, and as a reception area in at night. Each of these different uses will require different furniture which may require, for example, tables to be set up and taken down throughout the day. As another example, a school may have a multipurpose room that in which tables may be set out or removed according to the desired activity.

Hence, movable tables have been developed that are able to nest together for storage when not in use. Nesting of tables enables the tables to fit together while not in use to enable a larger number of tables to fit within a given space.

As laptop computers become prevalent, people sitting at a table are likely to need to plug their laptop into a electrical outlet to keep it charged. Accordingly, it is desirable to provide a source of power on tables. Accordingly, it would be advantageous to provide a movable table designed to be able to store in a compact manner that has an included source of electrical power.

### SUMMARY OF THE INVENTION

The following Summary and the Abstract set forth at the end of this application are provided herein to introduce some concepts discussed in the Detailed Description below. The Summary and Abstract sections are not comprehensive and are not intended to delineate the scope of protectable subject matter which is set forth by the claims presented below.

A table includes a folding modesty panel and integrated wire management system designed to fold against an underside of the table while retaining wires within the modesty panel. This allows a folding table to provide power at the working surface while in use, and enables the wires associated with the work surface power to be retained while the table is folded for storage. In one embodiment a folding portion of the modesty panel is shaped to retain the wires within a channel in both a folded position and a deployed position. When the table is to be folded for storage, the modesty panel is folded up against the underside of the work surface and the work surface is then pivoted to a vertical orientation. The channel wires are retained within the channel between the movable portion of the modesty panel and the underside of the work surface to secure the wires while the table is in the storage position. When the table is deployed, the modesty panel may be unfolded to extend below the underside of the work surface to obstruct a view of persons seated at the table. The modesty panel defines a channel in this deployed position as well, to also retain the wires while the modesty panel is in the unfolded deployed position.

### DRAWINGS

Aspects of the present invention are illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a front perspective view of a table with a folding modesty panel and integrated wire management system according to an embodiment of the invention, in which the folding modesty panel is folded against an underside of the table;

FIG. 2 is a side view of the table of FIG. 1;

FIG. 3 is a front perspective view of a table with a folding modesty panel and integrated wire management system according to an embodiment of the invention, in which the folding modesty panel is starting to be unfolded;

FIG. 4 is a side view of the table of FIG. 3;

FIG. 5 is a front perspective view of a table with a folding modesty panel and integrated wire management system according to an embodiment of the invention, in which the folding modesty panel is fully unfolded;

FIG. 6 is a side view of the table of FIG. 5; and

FIG. 7 is a cross-sectional view of a leg of one of the tables.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, and dimensions, have not been described in detail so as not to obscure the invention.

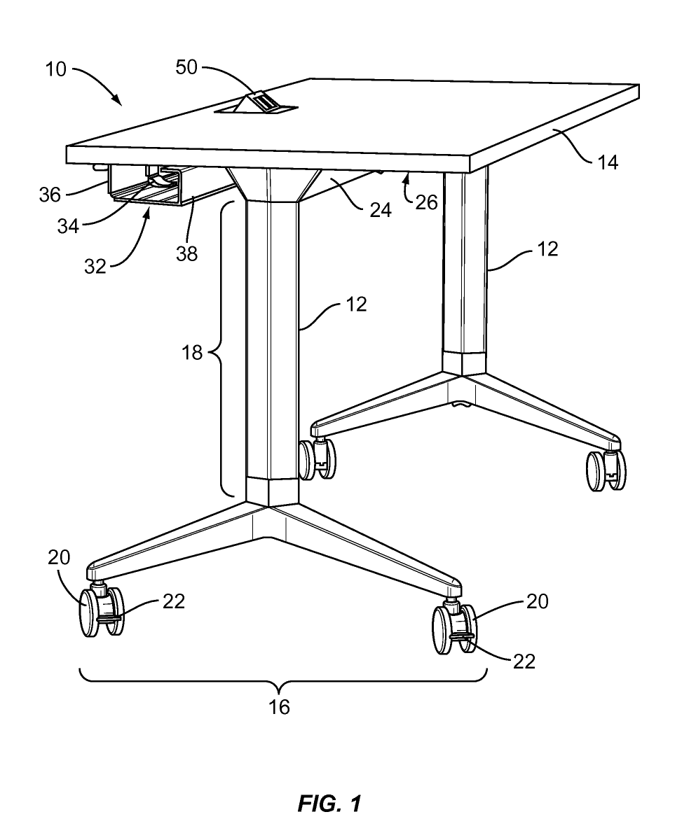

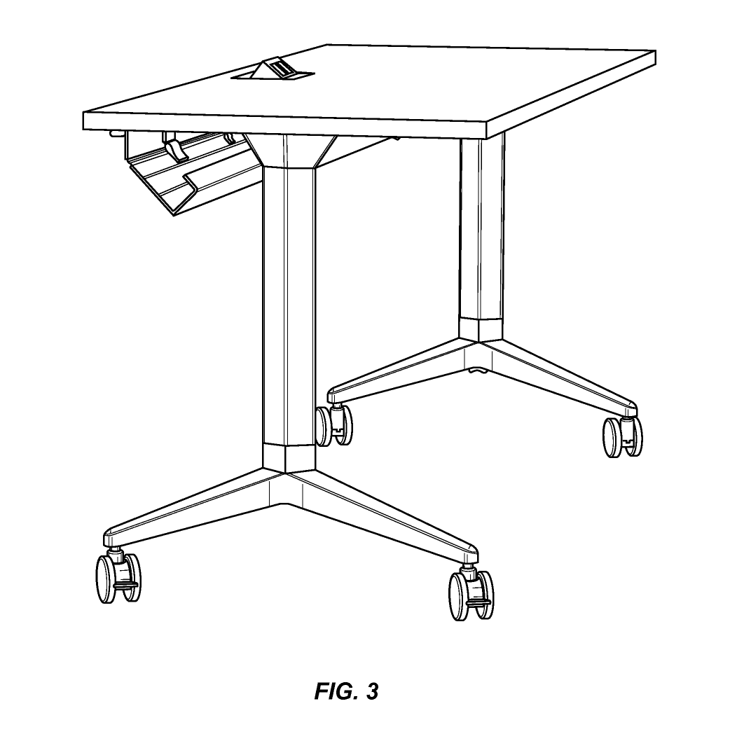

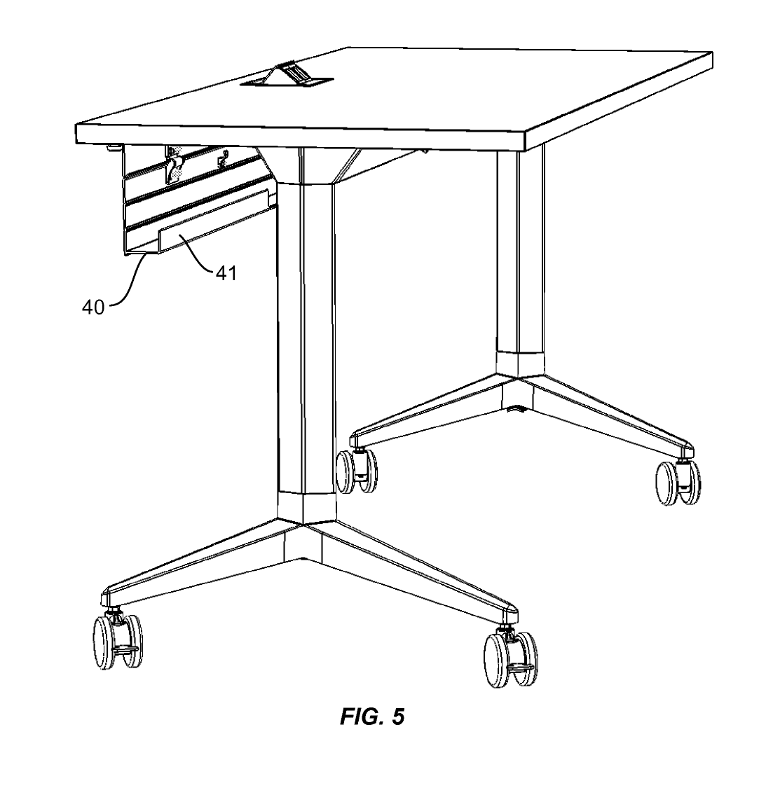

FIG. 1 is a front perspective view of a table with a folding modesty panel and integrated wire management system according to an embodiment of the invention, in which the folding modesty panel is folded against an underside of the table. FIGS. 3 and 5 show the table in successive positions as the modesty panel is further unfolded (FIG. 3) until it is extended to its fully unfolded position (FIG. 5).

In the embodiment shown in FIG. 1, the table 10 is a T-leg table having a pair of T-shaped legs 12 on either side to provide support to a table working surface 14. The T-shaped legs are generally shaped in the form of an up-side down letter T having a base 16 and stem 18. Castors 20 optionally may be provided on the base 16 to enable the table to be moved more easily. In the embodiment shown in FIG. 1, the castors 20 include locking mechanism 22 that will enable the wheels of the castors 20 to be locked to prevent the table from moving unintentionally. Optionally, leveling components may be included as well to enable the tables to be deployed for more permanent use.

The T-shaped legs are connected to a lateral support 24 extending between the T-shaped legs under the working surface 14. The lateral support 24 provides rigidity to the working surface 14 and also provides a frame to which the T-shaped legs may be attached. Preferably the lateral support is implemented to have a relatively low profile relative to the underside 26 of the table working surface 14 so that a user, sitting at the table, is not likely to bump their knees on the lateral support.

The lateral support 24 includes a lower portion 42 that is connected by a barrel hinge 46 to an upper plate 44. The upper plate 44 is secured to the underside 26 of the table working surface 14 and the lower portion 42 is connected to the stems 18 of the legs 12. A clasp 48 holds the table in a deployed position to lock the lower portion 42 to the upper plate 44 so that the table working surface is secured to the legs 12. When the table is to be stored, the clasp 48 may be released to enable the table working surface to be rotated about barrel hinge 46 so that the table may be collapsed for storage. This enables the table working surface to be placed in approximately a vertical plane so that multiple similar tables may be nested to be stored in a more compact manner.

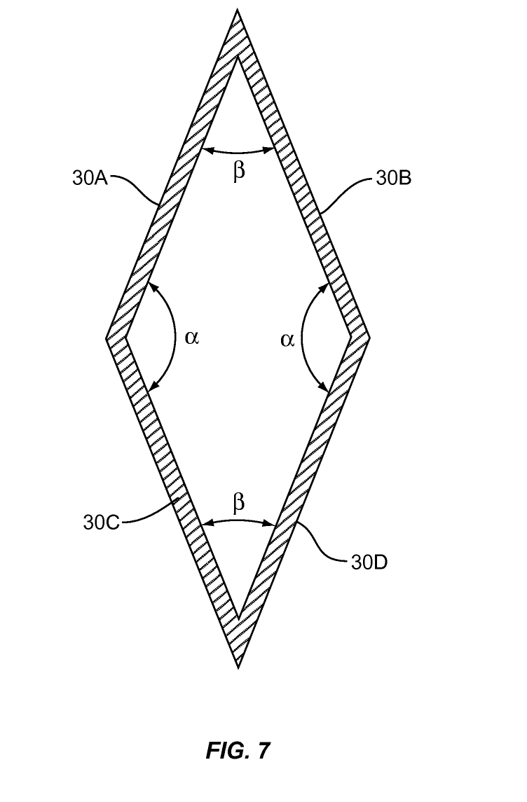

In one embodiment, as shown in FIGS. 1-6, the T-shaped legs may have a rhomboid cross-sectional profile. Particularly the stems 18 of the T-shaped legs 12 may be implemented to have a rhomboid cross-section. An example of a rhomboid cross-section is shown in FIG. 7. As shown in FIG. 7, a rhomboid has four sides 30A-30D of equal length, a first set of congruent angles α, and a second set of congruent angles β. Differently shaped legs may be used as well.

The table 10 includes a folding modesty panel 32 that may be deployed to provide privacy to persons seated at the table and also defines a wire management channel to hold wires associated with an on-table power supply. The folding modesty panel folds flat along the underside of the working surface to enable the tables to be nested for storage, and also extends to provide privacy to persons seated at the table. In both the folded storage position and the extended deployed position, and while transitioning between these positions, the folding modesty panel provides a cord storage channel that enables power and data cords to be stored regardless of the position of the modesty panel.

The folding modesty panel, in one embodiment, includes a fixed section 36 that is attached to the underside of the table working surface, and a movable section 38 that is connected to the fixed section. The movable section and fixed section may be separate pieces of material or may be formed by a suitable structure such as a living hinge (thin bendable portion of material) mechanical hinge, or other suitable structure.

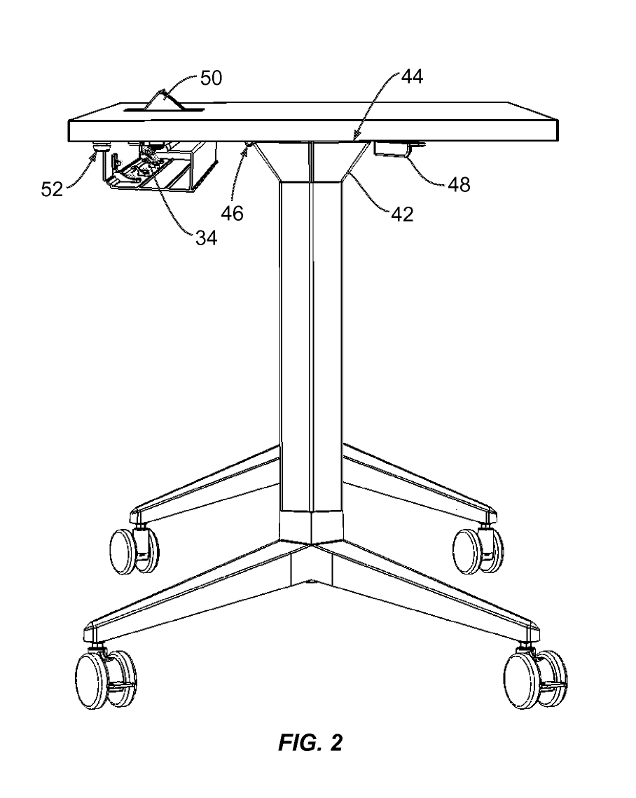

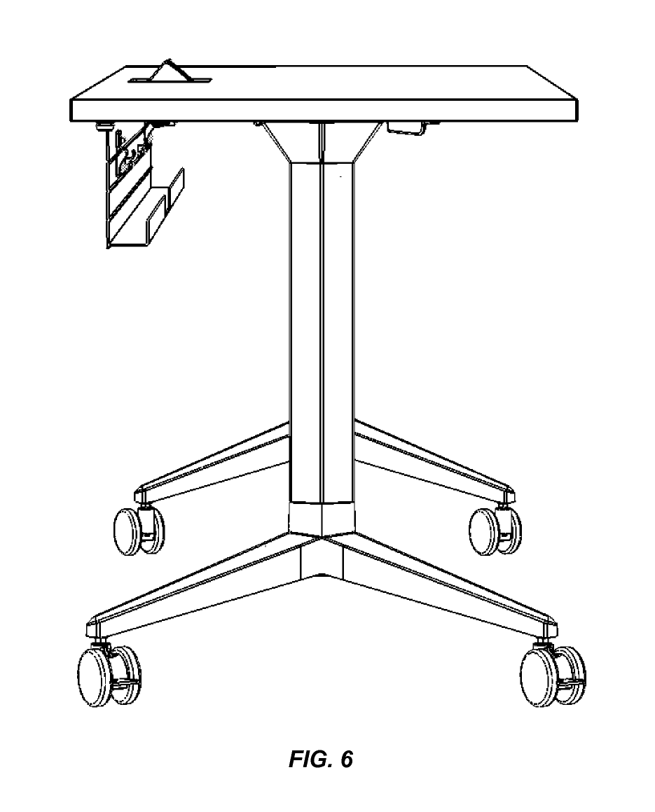

In one embodiment, the movable section of the modesty panel is connected to the fixed section of the table by hinges 34. Hinges 34 allow the movable section to be folded up and held in a storage position along the underside 26 of the table working surface 14 as shown in FIGS. 1-2. Hinges 34 also allow the movable section to be unfolded into a deployed position to extend downward from the underside 26 of the table working surface 14 (see FIGS. 5-6). In both positions the modesty panel defines a channel to retain wires associated with a desktop power source and/or data networking cables.

The hinges 34 may provide a locking mechanism to support the folding modesty panel 32 in the folded position as shown in FIGS. 1-2. Alternatively, a separate latching system may be used to latch the folding modesty panel in place to hold it along the underside of the table working surface when the tables are folded for storage.

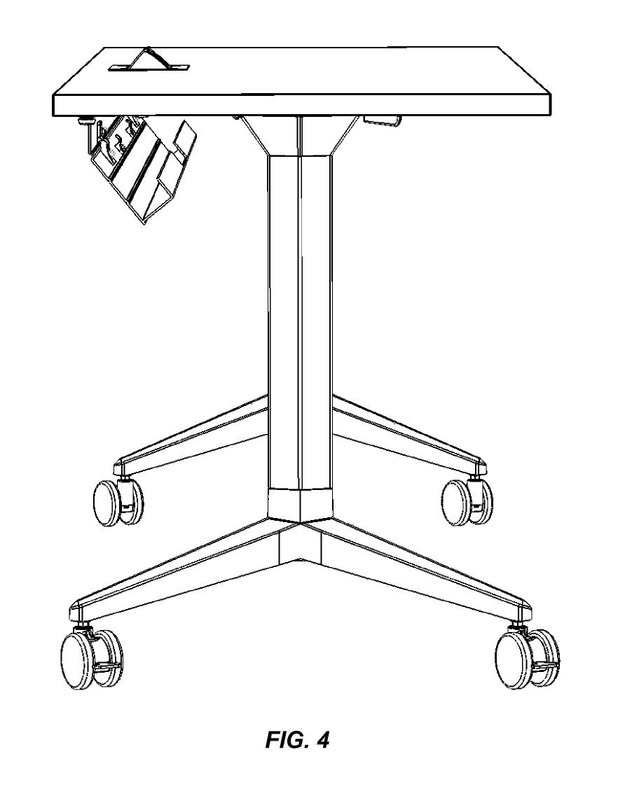

The folding modesty panel, in one embodiment of the invention, includes a bent section 40 and lip 41 that together form a J-shaped wire management channel. The J-shaped wire management channel enables wires to be retained by the modesty panel when the modesty panel is folded up along the underside of the table working surface (FIGS. 1-2), while the modesty panel is being unfolded (FIGS. 3-4), and after the modesty panel has been fully unfolded (FIGS. 5-6). This enables the power and data cords to be retained during use and storage so that the power/data cables are not required to be removed when the table is stored.

The table 10 may include a power module 50 to enable power to be provided on the table working surface to people sitting at the table in a convenient manner. The power module may have two conventional wall outlets to enable users to plug laptop computers or other types of electronic devices into the power module 50. Optionally, the power module may provide one or more data ports as well to also provide data network access to people seated at the table. The module 50 may be folded into the table when not required or when the tables are folded for storage.

Wires from the power module extend below the table through the wire management channel provided by the modesty panel to the edge of the table. A standard or proprietary plug structure may be included on the end of the power/data cables. Up to eight tables can be daisy chained together and receive power from a standard wall outlet to accommodate both individual and group applications—no hard wiring is necessary. Ganging clips 52 may also be provided to connect adjacent tables to each other to enable tables to be held in a steady configuration when groups of tables are used in rows.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A table, comprising:
a plurality of legs;
a table working surface supported by the legs; and
a folding modesty panel attached to the table working surface, the folding modesty panel being connected to the table working surface and having at least one folding portion that may selectively fold to be disposed adjacent an underside of the table working surface or to be selectively unfolded to extend away from the underside of the table working surface, the folding portion including a wire management channel to retain wires as the folding portion is folded and unfolded.

2. The table of claim 1, wherein the wire management channel comprises a J-shaped wire management channel.

3. The table of claim 2, wherein the J-shaped wire management channel enables wires to be retained by the modesty panel when the modesty panel is folded up along the underside of the table working surface, while the modesty panel is being unfolded, and after the modesty panel has been fully unfolded.

4. The table of claim 2, wherein the folding portion of the modesty panel has a flat section designed to extend away from the table working surface when unfolded, a bent section, and a lip.

5. The table of claim 4, wherein the bent section extends approximately 90 degrees from the flat section, and the lip extends approximately 90 degrees from the bent section, the bent section and lip defining a bottom of the J-shaped wire management channel.

6. The table of claim 1, wherein the folding modesty panel further comprises a fixed portion connected to an underside of the table working surface, and wherein the folding portion is hingedly connected to the fixed portion.

7. The table of claim 6, wherein the folding portion of the modesty panel has a flat section that is hingedly connected to the fixed portion on a first side and is designed to extend away from the table working surface when unfolded, the folding portion of the modesty panel further having a bent section that is connected to the flat section at a second side of the flat section at an approximate 90 degree angle to the flat section, the bent section further including a lip formed at a distal end to retain wires within a J-shaped channel defined by the flat section, bent section and lip.

8. The table of claim 7, wherein a width of the bent section is approximately equal to a width of the fixed portion.

9. The table of claim 1, wherein the table working surface is connected to the legs via one or more hinges to enable the table working surface to be pivoted to a vertical position for storage.

10. The table of claim 9, wherein the folding portion of the modesty panel enables the folding portion of the modesty panel to be folded to lie approximately parallel to the table while the table is in the vertical position.

11. The table of claim 9, further comprising locking hinges to retain the folding portion of the modesty panel adjacent the lower surface of the table while the table is in the vertical position.

12. The table of claim 9, wherein the folding portion of the modesty panel defines a J-shaped channel, which, when folded up into a folded position, causes the folding modesty panel to form a closed channel along an underside of the working surface of the table.
